(19) United States
(12) Patent Application Publication
(10) Pub. No.: US 2025/0106770 A1
(43) Pub. Date: Mar. 27, 2025

(54) RADIO WAKE-UP SIGNALS

(71) Applicant: Nordic Semiconductor ASA, Trondheim (NO)

(72) Inventors: Karol SCHOBER, Oulu (FI); Mauri NISSILÄ, Oulu (FI); Hanna-Liisa TIRI, Oulu (FI)

(73) Assignee: Nordic Semiconductor ASA, Trondheim (NO)

(21) Appl. No.: 18/730,699

(22) PCT Filed: Feb. 10, 2023
(86) PCT No.: PCT/EP2023/053395

§ 371 Date: Jul. 19, 2024

(30) Foreign Application Priority Data
Feb. 17, 2022 (GB) 2202150.5

(51) Int. Cl. H04W 52/02; H04L 5/00

(52) U.S. Cl. CPC H04W 52/0235; H04L 5/0007

(57) ABSTRACT

There is disclosed a radio system, and a method for operating a radio system. An orthogonal frequency-division multiple-access (OFDMA) radio signal is transmitted, which has information digitally modulated onto it as OFDMA symbols on subcarriers in a first set of symbol periods. The radio signal has a second set of symbol periods interleaved, with the first set of symbol periods in time, in which these subcarriers are unmodulated, so as to create a predetermined temporal pattern. The radio signal is received on a first radio apparatus, which demodulates and uses information from the modulated symbol periods of the predetermined temporal pattern. A second radio apparatus receives the same radio signal, detects the predetermined temporal pattern of modulated and unmodulated symbol periods in the received radio signal, and, in response, activates its radio module by generating an electrical wake-up signal.

### BACKGROUND OF THE INVENTION

This invention relates to wake-up signals for orthogonal frequency-division multiple-access (OFDMA) radio systems.

Transceiver devices in multi-access radio systems may save power by entering a lower-power “sleep” state when they are not actively receiving information over a radio channel. This may involve powering down some of their receiver circuitry (e.g. radio transceiver circuitry). In order for a device in a sleep state to become awake again, it is known to transmit a relatively simple “wake-up signal” to the device, which the device can listen for efficiently while in the sleep state. Following detection of this wake-up signal, the device can enter a wake state in which it is able to exchange more complex information through the radio system.

For example, the paper “IEEE 802.11ba Wake-Up Radio: Performance Evaluation and Practical Designs” by Deng et al., IEEE Access (2020), describes wake-up frames in the context of the IEEE 802.11ba standard.

Wake-up signals can desirably facilitate reduced power consumption by receiving devices. However, the transmission of wake-up signals in a orthogonal frequency-division multiple-access (OFDMA) radio system can undesirably occupy valuable bandwidth.

Embodiments of the present invention seek to address this challenge.

### SUMMARY OF THE INVENTION

From a first aspect, the invention provides a method for operating a radio system, the method comprising:
transmitting an orthogonal frequency-division multiple-access (OFDMA) radio signal, wherein the radio signal comprises information digitally modulated as one or more OFDMA symbols, on one or more subcarriers, in a first set of one or more symbol periods, and wherein, in a second set of one or more symbol periods, interleaved in time with the first set of one or more symbol periods, the one or more subcarriers are unmodulated, so as to provide a predetermined temporal pattern of modulated and unmodulated symbol periods across the one or more subcarriers;
receiving the radio signal on a first radio apparatus of the system;
the first radio apparatus demodulating and using information from one or more of the modulated symbol periods of the predetermined temporal pattern;
receiving the radio signal on a second radio apparatus of the system;
the second radio apparatus detecting the predetermined temporal pattern of modulated and unmodulated symbol periods in the received radio signal; and
in response to detecting the predetermined temporal pattern in the received radio signal, the second radio apparatus generating an electrical wake-up signal for activating a radio module of the second radio apparatus.

From a second aspect, the invention provides a radio system comprising a base station, a first radio apparatus, and a second radio apparatus, wherein:
the base station is arranged to transmit an orthogonal frequency-division multiple-access (OFDMA) radio signal, wherein the radio signal comprises information digitally modulated as one or more OFDMA symbols, on one or more subcarriers, in a first set of one or more symbol periods, and wherein, in a second set of one or more symbol periods, interleaved in time with the first set of one or more symbol periods, the one or more subcarriers are unmodulated, so as to provide a predetermined temporal pattern of modulated and unmodulated symbol periods across the one or more subcarriers;
the first radio apparatus is configured to receive the radio signal, and to demodulate and use information from one or more of the first set of symbol periods; and
the second radio apparatus is configured to receive the radio signal, to detect the predetermined temporal pattern of modulated and unmodulated symbol periods in the received radio signal, and, in response to detecting the predetermined temporal pattern in the received radio signal, to generate an electrical wake-up signal for activating a radio module of the second radio apparatus.

From a third aspect, the invention provides a radio apparatus for use in a radio system, wherein the radio apparatus comprises a radio module and a wake-up unit, wherein the radio module has a wake state and a sleep state, and wherein the radio apparatus is configured:
to receive orthogonal frequency-division multiple-access (OFDMA) radio signals, wherein each radio signal comprises information digitally modulated as one or more OFDMA symbols, on one or more subcarriers, in a first set of one or more symbol periods, and wherein, in a second set of one or more symbol periods, interleaved in time with the first set of one or more symbol periods, the one or more subcarriers are unmodulated, so as to provide a predetermined temporal pattern of modulated and unmodulated symbol periods across the one or more subcarriers;
when the radio module is in the wake state, to receive a first such radio signal, and to use the radio module to demodulate and use information from one or more of the first set of symbol periods of the first radio signal; and
when the radio module is in the sleep state, to receive a second such radio signal, and to use the wake-up unit to detect the predetermined temporal pattern of modulated and unmodulated symbol periods in the second radio signal, and, in response to detecting the predetermined temporal pattern in the second radio signal, to send an electrical wake-up signal from the wake-up unit to the radio module to cause the radio module to enter the wake state.

Thus it will be seen that, in accordance with embodiments of the invention, the same modulated symbols in an OFDMA radio signal can be used both to transmit data to one radio apparatus and to wake up another radio apparatus. Likewise, the same radio apparatus may wake in response to receiving one such radio signal (which may simultaneously be carrying information to another radio apparatus), and may use (e.g. decode) information from a later such radio signal (which may itself be being used to wake a different radio apparatus). The first and second sets of symbol periods, arranged in the predetermined temporal pattern, together provide a novel type of radio wake-up signal that does not need to consume as much resource overhead as a wake-up signal that does not communication any useful additional information.

The OFDMA radio signal(s) may be transmitted by a base station. The system may be any type of OFDMA radio system. It may be a cellular telecommunications system, which may support a 4G or 5G radio standard. The radio signal(s) may conform to current or future 5G new radio (NR) specification. The information may be modulated using any type of modulation, but in some embodiments it is modulated using quadrature amplitude modulation (QAM). Each modulated symbol period may contain a respective QAM symbol. The symbol periods may all be of equal duration.

The first, modulated set of symbol periods may comprise a plurality of symbol periods, at least two of which are separated in time by a symbol of the second set. The second, unmodulated set of symbol periods may comprise a plurality of symbol periods, at least two of which are separated in time by a symbol period of the first set. The modulated and unmodulated sets of symbol periods may be interleaved. The temporal pattern may have any length, e.g. consisting of 4, 8, 16, 32 or more symbol periods. It may conform to a Gold, Walsh, Barker, Hadamard, Kasami or M-sequence code, or any other binary pattern having strong auto-correlation performance, wherein one of the sets of symbol periods corresponds to the “1” bits and the other set of symbol periods corresponds to the “0” bits.

By transmitting unmodulated symbol periods within the wake-up signal, the radio signal may contain no or negligible energy within the second set of symbols (e.g. not significantly greater than a noise floor for the radio system). This can enable a radio apparatus to detect the wake-up signal efficiently.

The second radio apparatus may comprise a radio module (e.g. a radio transceiver) and a wake-up unit. In any of the aspects disclosed herein, the radio module may have a wake state and a sleep state, which may correspond to a wake state and a sleep state for the radio apparatus. The wake-up unit may be configured to detect when a wake-up signal (i.e. a radio signal comprising the predetermined temporal pattern) is received by the radio apparatus. The wake-up unit may be distinct from the radio module. The wake-up unit may be active when the radio module is in the sleep state. The wake-up unit may be inactive when the radio module is in the wake state, although this is not essential.

The radio apparatus (e.g. the second radio apparatus), or a wake-up unit thereof, may detect the predetermined temporal pattern by determining a time-series of energy values, each energy value representing an energy of the radio signal received by the radio apparatus at a respective time. It may cross-correlate the time-series of energy values with data representative of the predetermined temporal pattern, thereby determining a correlation value. It may determine if the correlation value satisfies a wake-up condition, and may, in response, generate the electrical wake-up signal.

The wake-up unit may comprise an envelope detector for determining the time-series of energy values. The envelope detector may comprise analogue circuitry, e.g. rectification circuitry. It may additional comprise digital circuitry for determining the energy values. The envelope detector may be configured to sample received energy, to determine the energy values, across the one or more subcarriers. It may measure total received energy across the one or more subcarriers. It may sample received energy at least once every symbol period, for the first and second sets of symbol periods. The wake-up unit may comprise a correlator for performing the cross-correlation.

The wake-up unit may comprise a memory for storing the data representative of the predetermined temporal pattern. The data may be permanently stored in memory, e.g. from manufacture, or the radio apparatus may be configured to receive the data representative of the predetermined temporal pattern in a radio signal which is decoded by the radio module. The wake-up unit may be coupled to the radio module by data channel for receiving configuration data from the radio module (e.g. the data representative of the predetermined temporal pattern). The memory may store a plurality of predetermined temporal patterns, and the radio apparatus may cross-correlate the time-series of energy values with data representative of each of the predetermined temporal patterns.

The wake-up unit may be coupled to the radio module by a wake-up line for sending the wake-up signal to the radio module.

The radio module may be provided by a semiconductor chip. The wake-up unit may be integrated on this chip, or it may be separate. The wake-up unit may be provided by a separate wake-up semiconductor chip.

The radio module may comprise logic for decoding information from received radio signals using a fast Fourier transform (FFT). The wake-up unit, by contrast, preferably does not have FFT logic, but instead detects the wake-up signal using the correlator. The wake-up unit preferably has a lower power consumption when active than does the radio module when decoding a radio signal. Therefore, using a wake-up signal in accordance with embodiments of the present invention when the apparatus is in the sleep state allows saving of power.

The first apparatus may use (e.g. decode) all the information that is modulated in the first set of one or more symbol periods, or only a portion thereof. It may use the information in any way, e.g. decoding data for further processing, or for performing a training or calibration operation (e.g. estimating signal strength or signal-to-noise ratio). One or more further radio apparatuses may also demodulate and use information from one or more of the first set of symbol periods. These may be the same modulated symbol periods as the first apparatus uses (e.g. where the radio signal is used to send a message to a group of devices), or they may be different modulated symbol periods of the first set of symbol periods (e.g. where different messages are sent to different devices within the same wake-up signal).

The radio signal may transmit digitally modulated information comprising control information or apparatus-specific data. Allocation information may be sent to one or more of the radio apparatuses (e.g. encoded in the radio signal) specifying frequency-time resource units from which the radio apparatus should decode information. In particular, allocation information may be sent to the first radio apparatus, allocating some or all of the first set of one or more symbol periods, on the one or more subcarriers, to the first radio apparatus. The first set of one or more symbol periods may be allocated across one or more time slots (e.g. 5G NR slots). The radio signal may comprise resource-unit allocation control information (e.g. downlink control information, DCI), which may be followed in time by apparatus-specific data (e.g. physical downlink shared channel, PDSCH, data) in the allocated resource units. The resource-unit allocation control information may allocate a radio apparatus resource units on the one or more subcarriers in the first set of one or more symbol periods (i.e. in the wake-up signal) and/or other resource units (i.e. outside the wake-up signal). Specifying the resource units may be achieved by giving an offset in number of symbols to wait in time following the end of the receipt of the resource-unit allocation control information.

Sometimes a base station may not need to transmit a wake-up signal in a given time period. In this case, the symbol periods that would otherwise be unmodulated for as part of wake-up signal may instead be allocated for downlink information. Thus, the symbol periods of the second set of one or more symbol periods may have respective temporal positions relative to a first instance of resource-unit allocation control information in the radio signal, and allocation information may be sent to the first radio apparatus indicating that a further set of symbol periods, having equivalent temporal positions relative to a second instance of resource-unit allocation control information, are allocated, on the one or more subcarriers, to the first radio apparatus for receiving information at the first radio apparatus.

The wake-up signal may be encoded a single subcarrier, but is preferably encoded on a plurality of subcarriers—i.e. the aforesaid one or more subcarriers may be two or more subcarriers. In this way, the difference in total module energy, across the plurality of subcarriers, between the modulated and unmodulated symbol periods may be increased. This may improve the cross-correlation accuracy. Different symbols may be encoded on two or more of the subcarriers in the same symbol period. This can allow more information to be communication within the wake-up signal. However, preferably the unmodulated symbol periods are unmodulated across the plurality of subcarriers.

The one or more subcarriers are preferably a plurality of contiguous subcarriers. This may simplify the energy detection in the wake-up unit, which may comprise a frequency filter for passing the plurality of contiguous subcarriers. It may be configured to sample aggregate energy across the plurality of contiguous subcarriers. The one or more subcarriers preferably span less than all of the subcarriers of an OFDMA frequency band of the radio system (e.g. a given carrier bandwidth). The radio signal may comprise further information digitally modulated on other subcarriers and/or symbol periods of an OFDMA frequency band.

The predetermined temporal pattern may be continuous, or it may be spread across a plurality of spaced-apart time intervals. These intervals may be spaced apart by one or more temporal gaps (e.g. in which the modulation status of the resource units may be variable). The second radio apparatus, or the wake-up unit, may exclude energy values corresponding to the one or more temporal gaps when performing the cross-correlation.

Each radio apparatus may be any respective radio device, such as a wireless sensor, industrial machine, vehicle, home appliance, mobile telephone, etc.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram of a multi-device radio system embodying the invention;

FIG. 2 is a radio apparatus of the system; and

FIG. 3 is resource grid diagram for an exemplary radio signal transmitted by embodiments of the invention.

### DETAILED DESCRIPTION

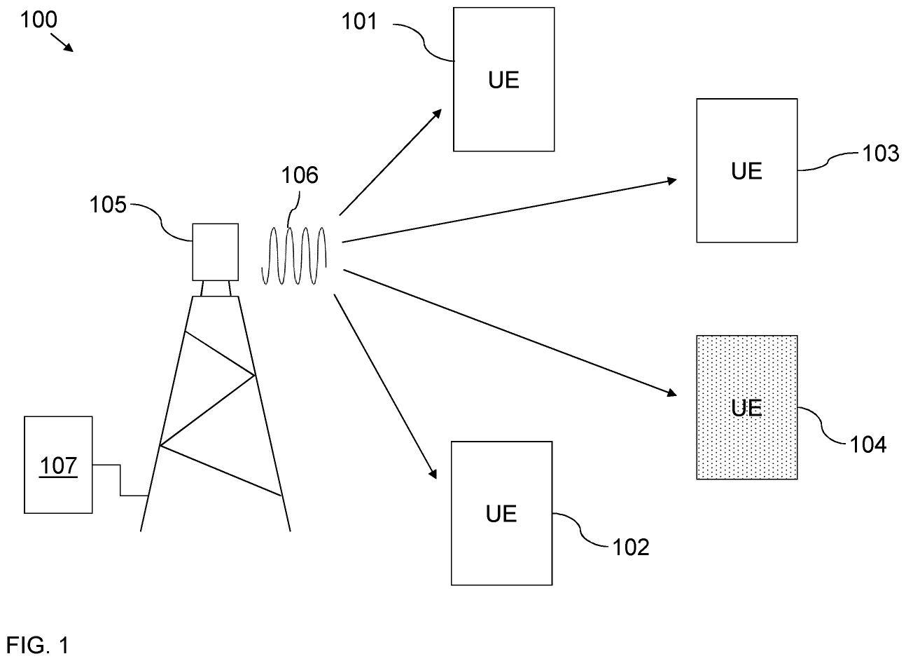

FIG. 1 shows a multi-device radio system 100 embodying the present invention. The system 100 may be a cellular telecommunication system, which may support a present or future mobile telecommunications standard. The radio system 100 comprises a number of user equipment (UE) devices 101-104 that are in radio range of a base station 105. The UE devices 101-104 may include mobile telephones, wireless sensors, machinery, vehicles, home appliances, etc. The base station 105 may be a component of a telecommunications network 107 that also comprises a backhaul network, which may be coupled to further base stations, as well as a mobile core and other conventional components. The system 100 may include other UE devices.

The base station 105 can transmit information to the UE devices 101-104 by a downlink radio signal 106, using digital modulation, according to an orthogonal frequency-division multiple access (OFDMA) system. The signal 106 is modulated on a plurality of subcarrier frequencies within an OFDMA frequency band (i.e. within a full carrier bandwidth). The OFDMA frequency band is also divided into a plurality of discrete time periods, such that it forms a grid of physical frequency-time resource units, distributed over both time and frequency. Each resource unit, which may be described in different OFDMA systems by various names (e.g. a “resource element” or “resource block”), occupies a set of one or more consecutive subcarriers in frequency (e.g. twelve subcarriers for a 4G or 5G physical resource block (PRB)), and a predetermined number of orthogonal frequency-division multiplexing (OFDM) symbol periods in time (e.g. one symbol in 5G, or seven symbols in 4G), and is the smallest time-frequency resource that can be allocated (i.e. scheduled) by the network 107 for communicating information to a UE device 101-104. The OFDM symbols may be modulated using quadrature amplitude modulation (QAM), e.g. with each resource unit encoding one bit, using binary phase-shift keying (BPSK), or with each resource unit encoding eight bits, using 256QAM. The telecommunications network 107 can dynamically allocate a set of resource units to one or more UEs 101-104 and then transmit information to the UE or UEs on the allocated resource units.

At least some of the UE devices 101-104 have a wake state and a sleep state and are designed to use less power when they are in the sleep state than they do when in the wake state. In particular, they can conserve electrical energy by powering down some of their radio transceiver circuitry when in the sleep state. However, the UE device then needs to be set to the wake state in order to decode information transmitted to it by the base station 105.

During a particular time period represented in FIG. 1, three of the UE devices 101-103 are in a wake state, while one UE device 104 is in the sleep state.

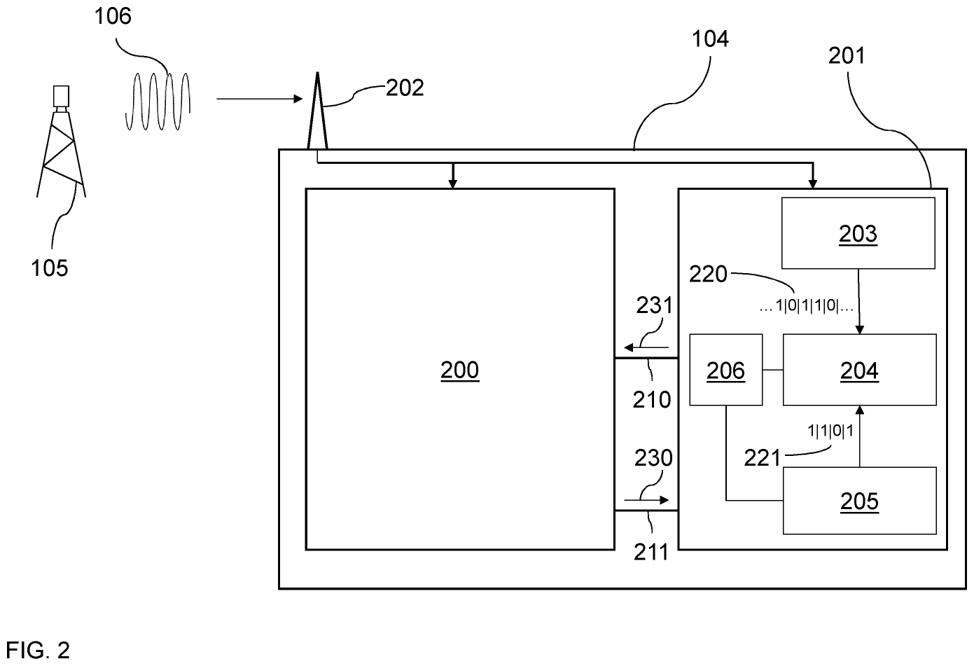

FIG. 2 shows a schematic diagram of an exemplary UE device 104 that can be switched between a wake state and a sleep state. The UE device 104 comprises a radio module 200 and a wake-up unit 201, each of which are electrically coupled to a radio antenna 202 of the device 104.

The radio module 200 comprises standard radio transceiver circuitry capable of decoding OFDMA signals, including the OFDMA signal 106 from the base station 105. It contains logic for performing a fast Fourier transform (FFT) on radio signals received at the antenna 202, and for processing the transformed data to decode information from an allocated set of resource units. It also contains circuitry for transmitting uplink signals to the base station 105.

The wake-up unit 201 is also connected to the antenna 202, but, in contrast to the radio module 200, it does not contain FFT logic for decoding information from incoming signals; instead it comprises an envelope detector 203, a correlator 204, a memory 205, and control logic 206. The correlator 204 could be implemented in software but in this embodiment is a hardware correlator.

The radio module 200 and wake-up unit 201 may be integrated in a common semiconductor chip, but in some embodiments the radio module 200 is provided by a semiconductor radio transceiver chip and the wake-up unit 201 is separate, e.g. being provided by discrete circuitry or as a semiconductor wake-up chip. The radio module 200 is electrically coupled to the wake-up unit 201 by a wake-up signal line 210 and by a configuration-data channel 211.

When the UE device 104 is in the sleep state, the radio module 200 does not attempt to decode an incoming radio signal 106 transmitted from the base station 105. Instead, the signal 106 is processed by the wake-up unit 201 to detect when the signal 106 contains a predetermined wake-up signal. This predetermined wake-up signal is sent by the telecommunications network 107, via the base station 105, in advance of sending downlink information to the device 4, in order to trigger the device 4 to leave the sleep state and enter the wake state.

The UE device 104 is configured with a predetermined set of resource units over which the wake-up signal will be transmitted. The wake-up unit 201 detects the wake-up signal by listening for a predetermined pattern of radio energy carried by these wake-up resource units. It does not demodulate and decode the incoming OFDMA signal 6, and therefore consumes much less energy than the radio module 200 does when the radio module 200 is actively receiving information by radio. The wake-up unit 201 may require less precise synchronisation compare to radio module 200, which may further reduce unit complexity and such power consumption.

The predetermined wake-up physical resource units may have been communicated to the UE device 104 (e.g. in a 5G SIB (system information block)) received by the radio module 200 when the UE device 104 was previously in the wake state.

Whenever the UE device 104 is in the sleep state, the wake-up unit 201 constantly establishes whether a wake-up signal has been received by the UE device 104. After appropriate tuning and filtering, the incoming radio-frequency (RF) spectrum is passed to the envelope detector 203, which repeatedly samples the received signal strength across the frequency range of the subcarriers of the wake-up physical resources. The received signal is filtered such that the envelope detector only samples signal strength in the frequency range of the subcarriers of the wake-up physical resources. The subcarriers used for the wake-up physical resources may be contiguous in frequency, meaning only one filter is required to limit the sampled frequency range. Multiple filters would be required if the subcarriers were split across the OFDM spectrum, rather than being continuous, requiring greater complexity in the wake-up unit 201. Resource units that contain modulated symbols will be determined to have a relatively high received energy, for example above −72 dBm, while resource units that are unmodulated will carry only background noise and so be determined to have a relatively low received energy. The envelope detector 203 outputs a sample stream representative of a temporal pattern 220 of received energy that depends on which of the wake-up resource units contain modulated symbols and which do not. This temporal pattern 220 of received energy is then passed to the correlator 204. The correlator 204 cross-correlates the incoming temporal pattern 220 with sample data representative of a predetermined expected wake-up pattern 221 which has been stored in the memory 205. If the predetermined wake-up physical resource blocks are not contiguous in time, the correlator 204 may be configured to correlate only on those energy samples that correspond to symbol periods of the wake-up resource units (i.e. to filter out energy samples from the envelope detector 203 from time periods lying outside the predetermined wake-up resource units).

The control logic 206 coordinates the behaviour of the components of the wake-up unit 201. In particular, it may configure the correlator 204 with the predetermined wake-up resource blocks and symbols that make up the resource units, e.g. based on configuration data 230 it receives from the radio module 200 over the data channel 211. It may comprise a processor and software, or may implement a finite state machine in hard-wired digital logic.

The use of energy envelope detection limits the power which the wake-up unit 201 needs to use to detect the wake-up signal. It avoids the need for processes such as a Fourier transform to decode the received signal 6, which would require more complex logic and consume greater power. This use of envelope detection, rather than a more complex decoding process, effectively uses on-off keying (OOK) to detect the wake-up pattern 221 as a binary string.

The expected wake-up pattern 221 may have been pre-loaded into the memory 205 when the device was manufactured or with a firmware update, or alternatively the expected wake-up pattern may have been previously transmitted to the UE device 104 by the telecommunications network 107 when the device 104 was in the wake state and connected to the network. Thus the control logic 206 may be configured to receive configuration data 230 encoding an updated wake-up pattern from the radio module 200 over the configuration data channel 211, which it may store in the memory 205.

The correlator 204 outputs correlation strength information (e.g. as a stream of correlation coefficients) to the control logic 206, which may detect a correlation peak in any appropriate, e.g. by detecting when the correlation strength passes above a predetermined threshold. If the correlation between the incoming temporal pattern of signal energy 220 and the expected wake-up pattern 221 indicates a match, the control logic 205 causes a wake-up command signal 231 to be sent from the wake-up unit 201 to the radio module 200 over the wake-up line 210. Alternatively, the wake-up command signal 231 may be sent to separate power management unit of the device 104, which may in turn wake the radio module 200. The radio module 200 enters a wake state and powers up its receive circuitry for demodulating the incoming OFDMA signal 106. The UE device 104 is thus restored to a wake state, ready to receive and decode information from the base station 105. Upon wake up, a radio module may start listening to paging, or may initiate communication with network.

Significantly, this approach does not depend on what particular OFDM symbols are modulated on the non-silent resource units of the wake-up signal. This allows the base station 105 to use the very same resource units both to wake the sleeping UE device 104 and to transmit useful information to one or more other UE devices 101-103. This allows for a very efficient allocation of spectral resources, which is particularly advantageous in regulated spectrum where there is typically a financial cost associated with spectral bandwidth use.

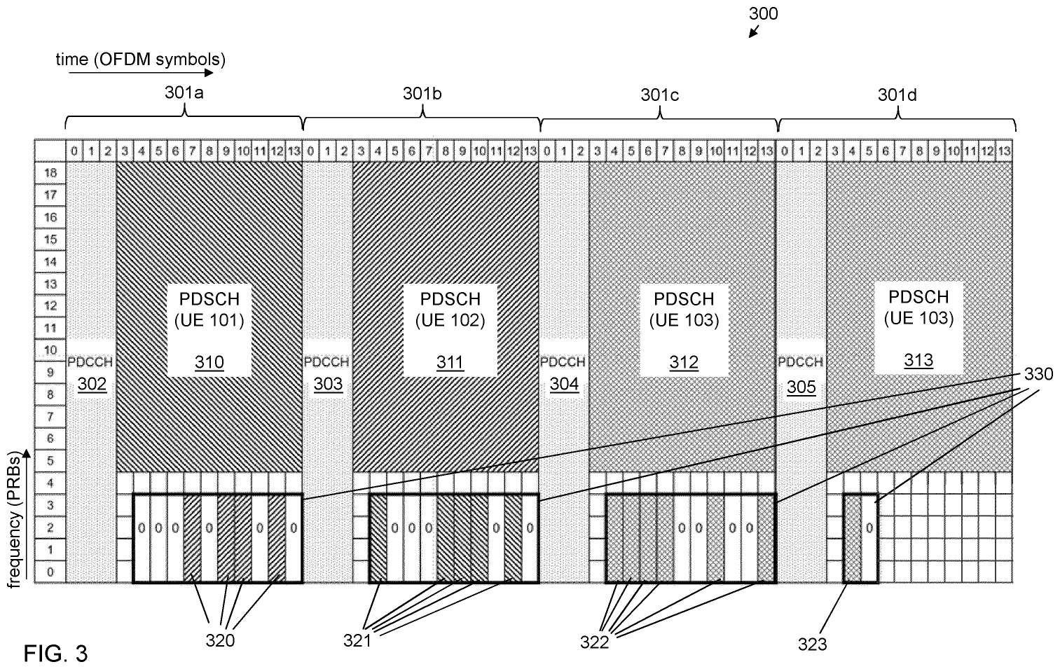

FIG. 3 shows an exemplary resource allocation grid 300 for a portion of a 5G downlink orthogonal frequency division multiple access (OFDMA) signal. This could, for instance, correspond to the OFDMA signal 106 transmitted by the base station 105. In 5G new radio (NR), frequency-time resources within the 5G spectrum can be allocated with a granularity of individual physical resource blocks (PRBs) in the frequency domain (where each resource block occupies twelve subcarriers), and of individual OFDM symbol periods in the time domain. The resource grid 300 in FIG. 3 represents nineteen PRBs along the frequency axis and fifty-six symbol periods along the time axis, with every fourteen OFDM symbol periods “0-13” defining a successive NR (New radio) slot 301, such that the grid 300 shown here represents four NR slots 301a-301d.

Some of the resource allocation 302-304 of the transmitted OFDMA signal 106 is assigned to transmit physical downlink control channel (PDCCH) information. Awake UE devices 101-103 attempt to decode the PDCCH signal to obtain downlink control information (DCI). The DCI schedules which resources will be allocated to a physical downlink shared channel (PDSCH) for each UE device 101-103. For example, DCI in the first PDCCH 302 may indicate the location of a large “legacy” PDSCH resource allocation 310 for the first UE 101 and a smaller PDSCH resource allocation 320 for the second UE 102, amongst other control information. The second PDCCH 303 may communicate the location of a large “legacy” PDSCH resource allocation 311 for the second UE 102 and a smaller allocation 321 for the first UE 101, while the third and fourth PDCCHs 304, 305 may communicate the locations of PDSCH resource allocations 312, 322, 313, 323 in the third and fourth slots all for the third UE 103. In this example, each PDCCH allocates resources in its own slot 301, but a PDCCH could alternatively indicate an non-zero slot offset from the PDCCH DCI to the PDSCH (i.e. to allocate resources in a later slot). The allocated PDSCH resources can be used to transmit user data and paging information to UE devices. In this way, PDSCH can be allocated to different UE devices 101-103 across the resource grid.

More specifically, in the example of FIG. 3, the first UE device 101 is scheduled for a “legacy” rectangle 310 of resource units occupying PRBs “5-18” in frequency and symbol periods “3-13” of the first slot 301a. However, the first UE device 101 is additionally scheduled a set 321 of resource units occupying PRBs “0-3” and symbols periods “3, 8, 9, 10, 12” of the second slot, which forms part of a novel wake-up signal 330 as disclosed herein. The second UE device 102 is allocated a “legacy” rectangle 311 of resource units occupying PRBs “5-18” and symbol periods “3-13” of the second slot 301b, and also a set 320 of resource units occupying PRBs “0-3” and symbol periods “7, 9, 10, 12” of the first slot. The third UE device 103 is allocated large “legacy” rectangles 312, 313 of PRBs and smaller sets 322, 323 of PRBs within the third and fourth slots 301c, 301d.

The smaller sets 320-323 of resources allocated to the three UE devices 101-103 can communicate information (e.g. data and paging information) to these devices 101-103, but they also form part of a wake-up signal 330 for signalling the fourth UE device 104 to wake from a sleep state and enter the wake state.

Physical resources for the wake-up signal 330 are allocated across thirty-two OFDM symbol periods, divided into four non-contiguous time intervals of ten symbol periods, as shown in FIG. 3, such that a sequence of unmodulated (silent) resource units (labelled with “0” in FIG. 3) is interleaved in time with a sequence of modulated resource units 320-323 according to a predetermined wake-up pattern 221. In this example, the wake-up signal 330 is spread across four slots 301a-d, separated by the second, third and four PDCCHs 303, 304, 305. It has the exemplary 32-bit pattern [0101000111010111100100110], but other wake-up signals may use any binary pattern with good autocorrelation properties, such as a Gold, Walsh, Barker, Hadamard, Kasami or M-sequence code, and may be of different bit lengths.

If the wake-up signal 330 is transmitted more than once, with the same temporal pattern, its resources will have the same relative positions in time at every transmission. For example, a demodulation reference signal (DMRS) for the wake-up signal 330 allocation might always be located at the first modulated OFDM symbol period of the slot-based scheduling in the selected wake-up pattern, whereas positions of DMRS's for PRBs outside the wake-up signal may be determined by legacy methods (e.g. according to a current 5G NR specification).

In the third slot 301c, PDSCH is allocated for the third UE device 103 both within the wake-up signal 330 and outside the wake-up signal 330. In this case it is not required that DMRS symbol(s) without and outside the wake-up signal 330 have the same positions in time. For example, the DMRS symbol for the wake-up signal 330 could always be located at the first modulated OFDM symbol, while positions of DMRS for other allocated PRBs 312 may be determined by the legacy methods.

To detect this wake-up signal 330, the envelope detector 203 in the wake-up unit 201 will detect the energy in frequencies corresponding to the subcarriers of the PRBs “0-3”. In response to receiving the OFDM signal shown in this grid 300, the envelope detector 9 would output low sample values during the unmodulated symbol periods of the wake-up signal 330 (labelled “0” in FIG. 3), and high sample values during the modulated symbol periods 320-323. The correlator 204 is controlled to correlate the energy samples taken within the symbols periods “4-13” of each successive slot 301 against stored template data representative of the expected energy levels of the wake-up signal 330. The correlator 204 ignores energy samples from within the PDCCH 303, 304 time periods.

As can be seen from FIG. 3, the modulated allocations 320-323 within the wake-up signal 330 are simultaneously used to signal the sleeping UE device 104 and also as PDSCH for other UE devices 101-103. For example, the resource units 322 are used for PDSCH of the third UE device 103. This UE device 103 will then provide a HARQ-ACK in response to receiving the PDSCH. By contrast, the envelope detector 109 in the wake-up unit 201 does not attempt to decode the information transmitted in the allocated wake-up physical resources 320-323. It therefore does not matter what information is modulated on the signal in the modulated allocations 320-323, only that there is transmitted radio energy present on those subcarriers and symbol periods.

By using the modulated allocations 320-323 of the wake-up signal 330 to transmit PDSCH data or paging information to other UE devices 101-103, the resource grid 300 is used very efficiently. Using an energy sequence for the wake-up signal 330 therefore not only saves power and complexity for the wake-up unit 201, but also reduces resource overhead for the radio system 100 overall.

In the case where a wake-up signal 330 does not need to be sent (for example, if the fourth UE device 104 is already awake), a Time Domain Resource Allocation (TDRA) field in the DCI information can indicate that all the symbols periods in the physical resources used for the wake-up signals 330 can be used for PDSCH allocation. A scheduling protocol for resource allocation which does not consider wake-up signals could also be invoked during periods when no wake-up signal 330 needs to be transmitted by the base station 105.

The UE devices may need to support networks that do not implement the present wake-up mechanism, as well as networks 107 that do. Legacy networks need not be configured to allocate PDSCH scattered within a wake-up signal 330, but might only support “legacy” allocations of larger PDSCH blocks. In order to signal to compatible UE devices that a network 107 supports wake-up signal allocations, the resource allocation (RA) field of a DCI format may be augmented by one bit—e.g. in front of a time-domain resource allocation (TDRA) field-compared with a current 5G specification, with this bit being used to signal to a UE device whether the network is allocating wake-up signal resources or whether it is it allocating only legacy resource allocation.

Alternatively or additionally, if an indicated legacy resource allocation (RA) field overlaps with the resource blocks and symbol of the wake-up signal resources, a UE device may be sent an additional indication as to whether or not PDSCH is rate-matched in the unmodulated (“0”) symbols of the wake-up signal in a slot.

Although the wake-up signal 330 has been described here as being sent to wake a single UE device 104, the same signal could be used to wake multiple devices simultaneously, so long as the multiple devices have been configured to correlate against stored data representative of the same predetermined temporal pattern (e.g. by the network 107 having sent appropriate template data to be stored in the local memories 205 of the wake-up units 201 of the devices before they entered a sleep state).

In some embodiments, a UE device 104 may be configured to detect any of a plurality of wake-up signals, each having a different OOK pattern. This can allow the device to be a member of multiple different groups of devices, where each group can be woken with a different wake-up signal. When asleep, the UE device may cross-correlate incoming signal energy against all of the patterns, and wake if there is a match on any of them. Data representative of each of the patterns may be stored in the memory 205 of the wake-up unit 201.

In some embodiments, every UE device may be configured with the same library of multiple wake-up signal patterns, and, when allocating resources within a wake-up signal, the network 107 may indicate which pattern is being used. This may be signalled using a field in the DCI. For example, by reusing the frequency-domain resource allocation (FDRA) field or parts of it.

Although FIG. 3 shows PDSCH being sent within the wake-up signal 330 to different individual UE devices 101-103, it will be appreciated that the same information could be received and decoded by a group of UE devices.

FIG. 3 shows the wake-up signal 330 being spread across four consecutive PRBs in frequency, however it could be transmitted on just a single PRB, or over any other number of PRBs or subcarriers.

It will be appreciated by those skilled in the art that the invention has been illustrated by describing one or more specific embodiments thereof, but is not limited to these embodiments; many variations and modifications are possible, within the scope of the accompanying claims.

1. A method for operating a radio system, the method comprising:
transmitting an orthogonal frequency-division multiple-access (OFDMA) radio signal, wherein the radio signal comprises information digitally modulated as one or more OFDMA symbols, on one or more subcarriers, in a first set of one or more symbol periods, and wherein, in a second set of one or more symbol periods, interleaved in time with the first set of one or more symbol periods, the one or more subcarriers are unmodulated, so as to provide a predetermined temporal pattern of modulated symbol periods and unmodulated symbol periods across the one or more subcarriers;
sending allocation information to a first radio apparatus indicating that some or all of the first set of one or more symbol periods, on the one or more subcarriers, are allocated to the first radio apparatus;
receiving the radio signal on the first radio apparatus of the radio system;
the first radio apparatus demodulating and using information from one or more of the modulated symbol periods of the predetermined temporal pattern;
receiving the radio signal on a second radio apparatus of the radio system;
the second radio apparatus detecting the predetermined temporal pattern of modulated symbol periods and unmodulated symbol periods in the received radio signal; and
in response to detecting the predetermined temporal pattern in the received radio signal, the second radio apparatus generating an electrical wake-up signal for activating a radio module of the second radio apparatus.

2. The method of claim 1, wherein the second radio apparatus detecting the predetermined temporal pattern comprises the second radio apparatus:
determining a time-series of energy values, each energy value representing an energy of the radio signal received by the second apparatus at a respective time;
cross-correlating the time-series of energy values with data representative of the predetermined temporal pattern, thereby determining a correlation value; and
determining if the correlation value satisfies a wake-up condition.

3. The method of claim 1- or 2, wherein the radio signal is transmitted by a base station of a cellular telecommunications system.

4. The method of claim 1, wherein the predetermined temporal pattern comprises a plurality of modulated symbol periods and a plurality of unmodulated symbol periods.

5. The method of claim 1, wherein the one or more subcarriers are a plurality of subcarriers, and wherein, for at least one symbol period of the first set of one or more symbol periods, at least two of the plurality of subcarriers encode different respective symbols.

6. The method of claim 1, wherein the one or more subcarriers are a plurality of contiguous subcarriers.

7. The method of claim 1, wherein the allocation information sent to the first radio apparatus indicates that only some of the first set of one or more symbol periods are allocated, on the one or more subcarriers, to the first radio apparatus.

8. The method of claim 1, comprising a further radio apparatus receiving the radio signal, and demodulating and using information from one or more of the first set of one or more symbol periods.

9. The method of claim 8, further comprising sending allocation information to the further radio apparatus, wherein the allocation information sent to the first radio apparatus and the allocation information sent to the further radio apparatus specify respective frequency-time resource units from which each radio apparatus should decode information.

10. The method of claim 9, wherein the allocation information sent to the first radio apparatus allocates a first subset of one or more of the first set of one or more symbol periods on the one or more subcarriers to the first radio apparatus, and wherein the allocation information sent to the further radio apparatus allocates a second subset of the one or more of the first set of one or more symbol periods on the one or more subcarriers to the further radio apparatus, wherein the second subset is different from the first subset.

11. The method of claim 8, comprising the further radio apparatus demodulating and using information on the one or more subcarriers from one or more of the first set of one or more symbol periods that are different from the one or more of the first set of one or more symbol periods that the first radio apparatus demodulates and uses information from.

12. The method of claim 1, wherein the radio signal contains no or negligible power on each of the one or more subcarriers in each of the second set of one or more symbol periods.

13. The method of claim 1, wherein the symbol periods of the second set of one or more symbol periods have respective temporal positions relative to a first instance of resource-unit allocation control information in the radio signal, and wherein the method further comprises sending allocation information to the first radio apparatus indicating that a further set of symbol periods, having equivalent temporal positions relative to a second instance of resource-unit allocation control information, are allocated, on the one or more subcarriers, to the first radio apparatus for transmitting information to the first radio apparatus.

14. A radio system comprising a base station, a first radio apparatus, and a second radio apparatus, wherein:
the base station is arranged to transmit an orthogonal frequency-division multiple-access (OFDMA) radio signal, wherein the radio signal comprises information digitally modulated as one or more OFDMA symbols, on one or more subcarriers, in a first set of one or more symbol periods, and wherein, in a second set of one or more symbol periods, interleaved in time with the first set of one or more symbol periods, the one or more subcarriers are unmodulated, so as to provide a predetermined temporal pattern of modulated symbol periods and unmodulated symbol periods across the one or more subcarriers;
the first radio apparatus is configured to receive allocation information indicating that some or all of the first set of one or more symbol periods, on the one or more subcarriers, are allocated to the first radio apparatus;
the first radio apparatus is configured to receive the radio signal, and to demodulate and use information from one or more of the first set of one or more symbol periods; and
the second radio apparatus is configured to receive the radio signal, to detect the predetermined temporal pattern of modulated symbol periods and unmodulated symbol periods in the received radio signal, and, in response to detecting the predetermined temporal pattern in the received radio signal, to generate an electrical wake-up signal for activating a radio module of the second radio apparatus.

15. A radio apparatus for use in a radio system, wherein the radio apparatus comprises a radio module and a wake-up unit, wherein the radio module has a wake state and a sleep state, and wherein the radio apparatus is configured:
to receive orthogonal frequency-division multiple-access (OFDMA) radio signals, wherein each radio signal comprises information digitally modulated as one or more OFDMA symbols, on one or more subcarriers, in a first set of one or more symbol periods, and wherein, in a second set of one or more symbol periods, interleaved in time with the first set of one or more symbol periods, the one or more subcarriers are unmodulated, so as to provide a predetermined temporal pattern of modulated symbol periods and unmodulated symbol periods across the one or more subcarriers;
when the radio module is in the wake state, to receive a first such radio signal, and to use the radio module to demodulate and use information from one or more of the first set of one or more symbol periods of the first radio signal; and
when the radio module is in the sleep state, to receive a second such radio signal, and to use the wake-up unit to detect the predetermined temporal pattern of modulated symbol periods and unmodulated symbol periods in the second radio signal, and, in response to detecting the predetermined temporal pattern in the second radio signal, to send an electrical wake-up signal from the wake-up unit to the radio module to cause the radio module to enter the wake state; and
wherein the radio module is further configured to receive allocation information, allocating to the radio apparatus some or all of the first set of one or more symbol periods on the one or more subcarriers of the first radio signal, and to process the allocation information before decoding information from the one or more of the first set of one or more symbol periods of the first radio signal.

16. The radio apparatus of claim 15, configured to detect the predetermined temporal pattern of modulated symbol periods and unmodulated symbol periods by:
determining a time-series of energy values, each energy value representing an energy of the radio signal received by the second apparatus at a respective time;
cross-correlating the time-series of energy values with data representative of the predetermined temporal pattern, thereby determining a correlation value; and
determining if the correlation value satisfies a wake-up condition.

17. The radio apparatus of claim 15, wherein the wake-up unit comprises an envelope detector configured to determine a time-series of energy values by sampling received energy on the one or more subcarriers.

18. The radio apparatus of claim 17, wherein the envelope detector is configured to sample received radio energy at least once every symbol period for the first and second sets of symbol periods.

19. The radio apparatus of claim 16, wherein the wake-up unit comprises a correlator configured to cross-correlate the time-series of energy values with data representative of the predetermined temporal pattern, thereby determining a correlation value, and wherein the wake-up unit is configured to determine if the correlation value satisfies a wake-up condition.

20. The radio apparatus of claim 15, wherein the wake-up unit comprises a memory for storing data representative of the predetermined temporal pattern, and wherein the radio apparatus is configured to receive the data representative of the predetermined temporal pattern in a radio signal decoded by the radio module.

21. The radio apparatus of claim 15, wherein the radio module is provided by a first semiconductor chip and wherein the wake-up unit is separate from the first semiconductor chip.

22. The radio apparatus of claim 15, wherein the radio module comprises logic for decoding information from received radio signals using a fast Fourier transform (FFT).
